(19) United States
(12) Patent Application Publication
(10) Pub. No.: US 2009/0237354 A1
(43) Pub. Date: Sep. 24, 2009

(54) OPTICAL APPARATUS AND OPTICAL SYSTEM

(75) Inventor: Tsutomu ABE, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/241,135

(22) Filed: Sep. 30, 2008

(30) Foreign Application Priority Data
Mar. 19, 2008 (JP) 2008-071339

(51) Int. Cl. G09G 5/00

(52) U.S. Cl. 345/156

(57) ABSTRACT

An optical apparatus has a projection device that projects a projection image onto a projection area, and a capture device that is arranged so that the position of a principal point of the projection device optically corresponds with that the position of a principal point of the capture device, and captures the projection area. At least one of the projection device and the capture device has an optical system with a tilt angle, and the projection device and the capture device are arranged so that a line passing the center of an angle of field of the projection device and a line passing the center of an angle of field of the capture device correspond with each other.

### CROSS-REFERENCE TO RELATED APPLICATION

This application is based on and claims priority under 35 USC 119 from Japanese Patent Application No. 2008-071339 filed Mar. 19, 2008.

### BACKGROUND

1. Technical Field

This invention relates to an optical apparatus and an optical system including an image capture device and a projector.

2. Related Art

There has been conventionally known an indication system includes a server (e.g. a computer) with which a camera and a projector are connected, and a client (e.g. a computer) connected with the server via a network.

Conventionally, there has been sold a projector that is put on table and projects an image to a screen, and a projector that hangs from a ceiling and projects the image to the screen. This type of projector adopts an optical system with a tilt, and is called a projector with a tilt angle. The tilt angle means an angle formed between a line vertically drawn from the screen where the image from the projector is displayed to the projector, and a line that passes the center of the image projected with the projector. FIG. 8A shows an example of a projector with no tilt angle, and FIG. 8B shows an example of the projector with the tilt angle.

### SUMMARY

According to an aspect of the present invention, there is provided an optical apparatus including a projection device that projects a projection image onto a projection area; and a capture device that is arranged so that the position of a principal point of the projection device optically corresponds with that the position of a principal point of the capture device, and captures the projection area; wherein at least one of the projection device and the capture device has an optical system with a tilt angle, and the projection device and the capture device are arranged so that a line passing the center of an angle of field of the projection device and a line passing the center of an angle of field of the capture device correspond with each other.

### BRIEF DESCRIPTION OF THE DRAWINGS

Exemplary embodiments of the present invention will be described in detail based on the following figures, wherein:

FIG. 1 is a block diagram showing the construction of an optical apparatus in accordance with an exemplary embodiment of the present invention;

FIGS. 2A and 2B are schematic diagrams showing the construction of a projector 4;

FIG. 3 is a diagram showing position relationship between a main unit 6 and an object 9;

FIG. 4 is a schematic diagram showing the construction of the main unit 6;

FIG. 5 is a diagram showing an example of the specifications of the projector 4;

FIGS. 6A to 6D are diagrams showing examples of arrangement relationship between the projector 4 and a camera 5;

FIGS. 7A and 7B are schematic diagrams showing the construction of camera 5 which adopts an optical system with a tilt; and

FIGS. 8A and 8B are diagrams showing examples of conventional relationship between an optical axis of a projector and an axis which passes the center of an angle of field.

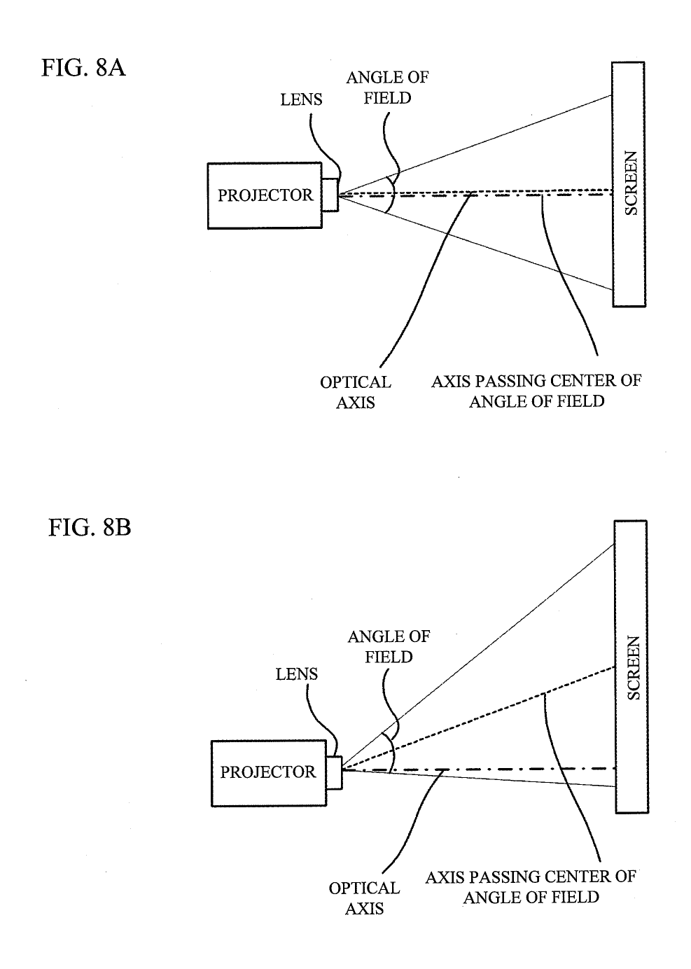

### DETAILED DESCRIPTION

A description will now be given, with reference to the accompanying drawings, of an exemplary embodiment of the present invention.

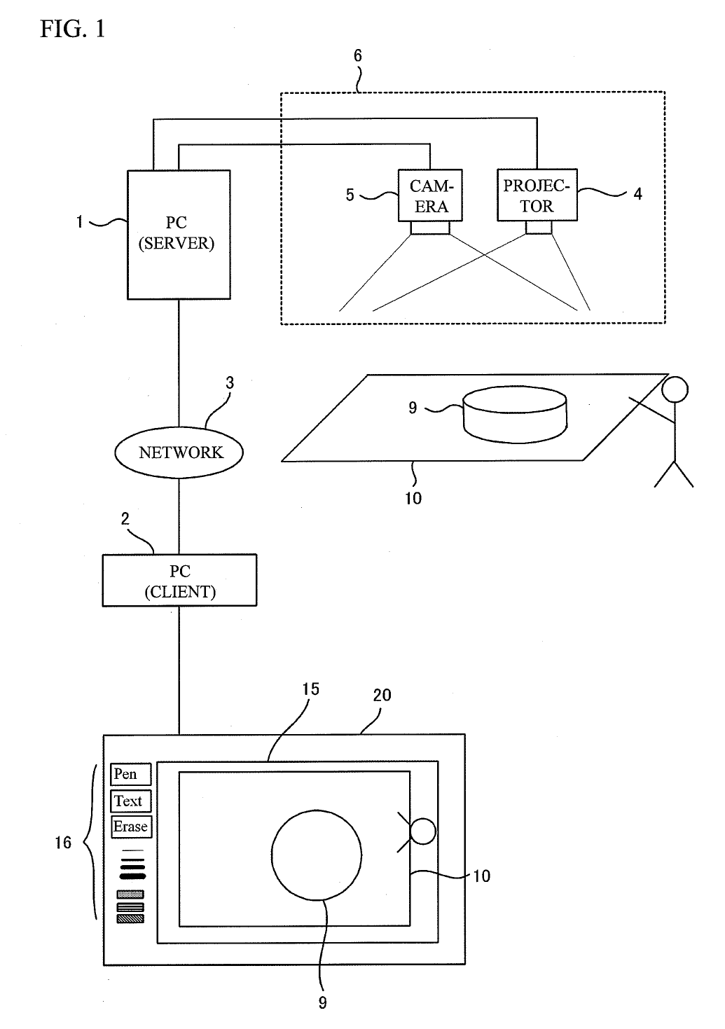

FIG. 1 is a block diagram showing the construction of an optical apparatus in accordance with an exemplary embodiment of the present invention.

The optical apparatus in FIG. 1 is provided with a personal computer (PC) 1 functioning as a server (an information processing apparatus), and a personal computer (PC) 2 functioning as a client. These elements are connected to each other via a network 3. It should be noted that there may be or may not be the PC 1, and a projector 4 and a camera 5 which are described later may be connected to the PC 2 directly or via a network.

The projector 4 (a projection device) and the camera 5 (an image capture device) are connected to the PC 1. The projector 4 and the camera 5 compose a main unit 6, and are built into a box-shaped case. Although the projector 4 and the camera 5 are arranged in parallel, the projector 4 and the camera 5 are practically arranged so that the principal points of the projector 4 and the camera 5 optically correspond with each other via a half mirror. Optimally, a projection area of the projector 4 and a capture area of the camera 5 correspond with each other.

Based on a control command from the PC 1, the projector 4 emits a simple light or projects an annotation image or the like onto an object 9 placed on a table 10. It should be noted that the annotation image includes an image of any types such as a line, a character, a symbol, a figure, a color, and a font.

The camera 5 is composed of a PTZ (Pan-Tilt-Zoom) camera or a video, captures an reflection image of the table 10 including an object 9, and outputs a capture image to the PC 1. In the exemplary embodiment, the camera 5 adopts an optical system in which a central axis of a capture lens corresponds with a vertical line (i.e., a normal line) in a central part of a light-receiving element, i.e., a so-called optical system with no tilt angle.

The PC 1 outputs image captured by the camera 5 to the PC 2 via the network 3. A display unit 20 composed of a monitor or the like is connected to the PC 2, and the display unit 20 displays a display area 15 of the captured image, and a user interface (UI) 16. It should be noted that the PC 2 may be composed of an all-in-one personal computer including the display unit 20.

Two sets of a microphone and a speaker, not shown, are connected to the PC 1 and the PC 2, respectively, and the users of the PC 1 and the PC 2 communicate with each other by voice with the two sets of the microphone and the speaker.

The UI 16 includes a group of buttons such as a pen button, a text button, and an erase button, and icons defined by lines and colors. The image captured by the camera 5 is displayed on the display area 15. In FIG. 1, the image of the table 10 including the object 9 captured by the camera 5 is displayed on the display area 15.

For example, when the pen button of the UI 16 is pressed to draw a figure or the like on the object 9 in the display area 15, the information about the figure is output from the PC 2 to the projector 4 via the PC 1. The projector 4 projects the figure onto the object 9 based on the information about the figure.

Thus, information or the like drawn on the object 9 or around the object 9 is transmitted to the PC 2 as an image. In the PC 2, the annotation image is written into the image, so that the annotation image is projected on the object 9 or around the object 9. Therefore, the user of a side of the object 9 and the user a side of the PC 2 may execute the communication such as a conference with each other.

The PC 2 outputs control commands to the PC 1 so as to control operations of the projector 4, and the camera 5 (such as a capture angle and brightness of image captured by the camera 5, and brightness of image projected by the projector 4).

In FIG. 1, the number of clients is only one (the PC 2), but the indication system may include two or more clients (PCs).

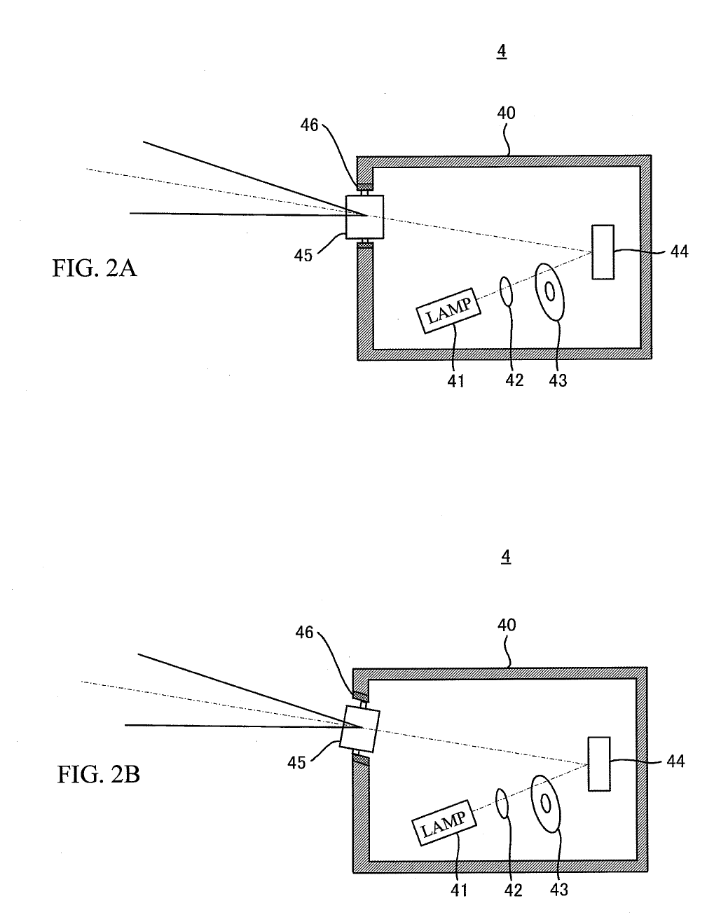

FIGS. 2A and 2B are schematic diagrams showing the construction of the projector 4.

The projector 4 is composed of a projector with the tile angle which utilizes a DLP (Digital Light Processing) of Texas Instruments Ltd.

The projector 4 includes a lamp 41, a projection lens 42, a color wheel 43, a digital micro-mirror device (DMD) 44, and a projection lens unit 45. The lamp 41, the projection lens 42, the color wheel 43, and the digital micro-mirror device (DMD) 44 are built in a case 40, and the projection lens unit 45 is fixed to an engaging part 46 provided at one place of the case 40.

In the projector 4, a light from the lamp 41 is transmitted through the color wheel 43 of RGB colors via the projection lens 42, and emitted to the DMD 44. The color wheel 43 separates the light from the lamp 41 into three primary colors of RGB. The DMD 44 reflects the incident light (i.e., image of each color) to the projection lens unit 45.

The projector 4 has a tilt angle.

When an optical system of the projector 4 has a tilt angle, it is easy to receive the influence of the lens aberration of the projector lens. Therefore, as shown in FIG. 2B, the engaging part 46 is tilted from a horizontal surface by an amount of an angle in which a line (i.e., the optical axis) passing the center of the projection lens unit 45 corresponds with a line passing the center of an angle of field. Accordingly, the projection lens unit 45 fixed to the engaging part 46 is also tilted from the horizontal surface by the amount of the angle, and hence the influence of the lens aberration of the projection lens is reduced.

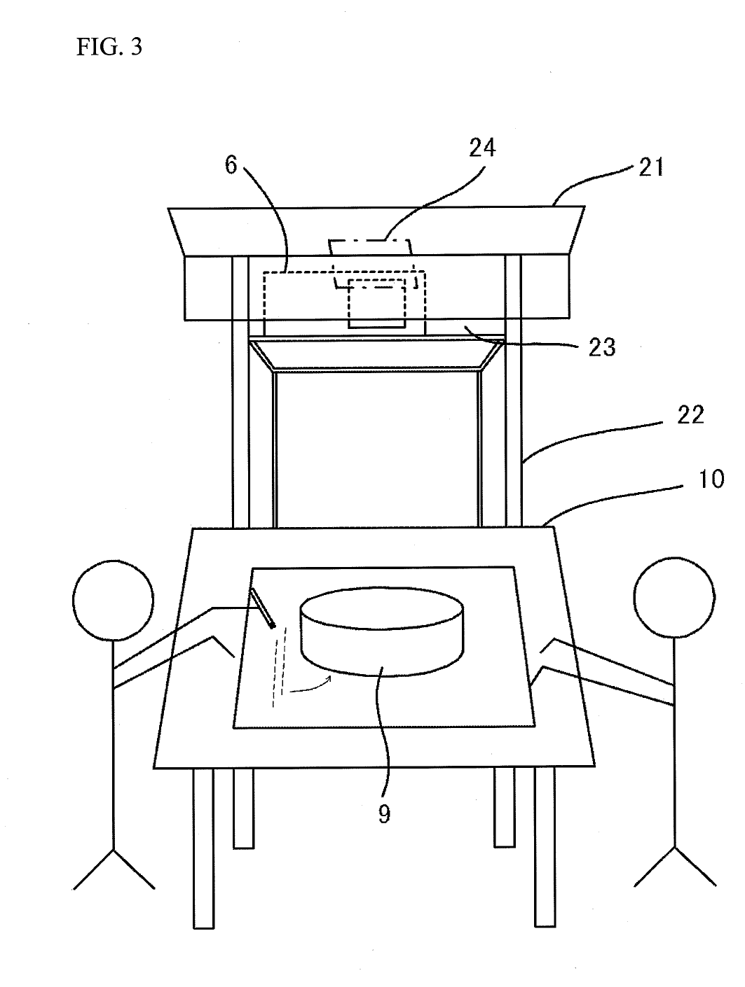

FIG. 3 is a diagram showing position relationship between the main unit 6 and the object 9.

A rack 22 with a shade 21 is placed above the table 10. In the rack 22, a storage unit 23 storing the main unit is provided. A mirror 24 which guides a projection light to the side of the object 9, and guides a reflection light reflected from the table 10 and the object 9 to the main unit 6 is provided in the shade 21. The main unit 6 acquires the image of the object 9 via the mirror 24, and projects the annotation image onto the object 9 and the table 10 via the mirror 24.

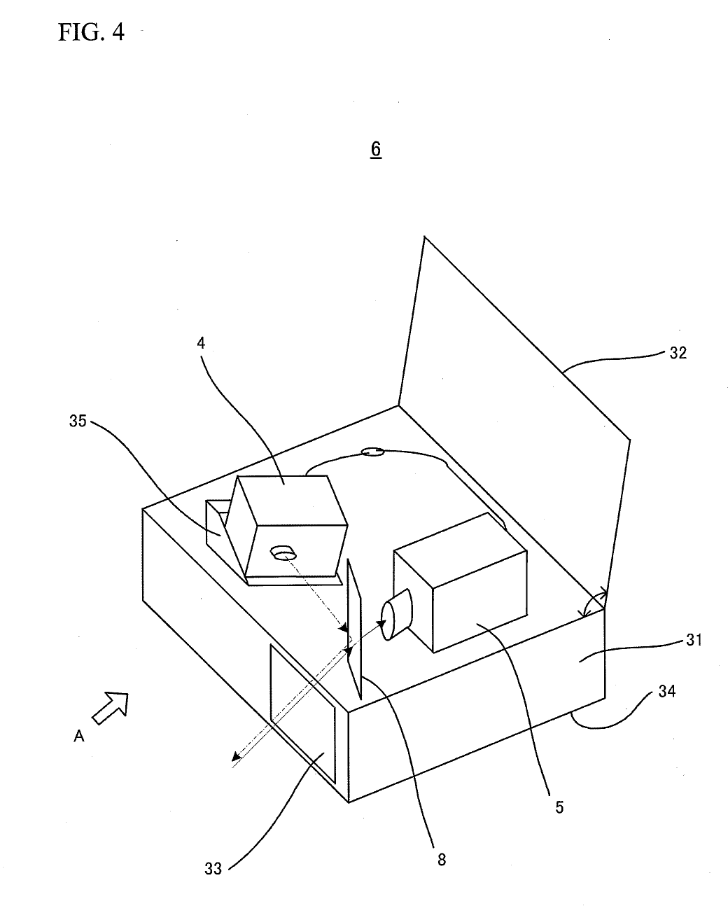

FIG. 4 is a schematic diagram showing the construction of the main unit 6.

The main unit 6 has a box-shaped housing 31. The housing 31 has an opening 33 for inputting the reflection light and outputting the projection light in a part of a side surface, and further has a top panel 32 which opens and closes, and a bottom plate 34. Inside the housing 31, the projector 4 and the camera 5 are provided, and a half mirror 8 that makes the positions of principal points of the projector 4 and the camera 5 optically correspond with each other is further provided. Here, the line passing the center of the angle of field of the camera 5 and the line passing the center of the angle of field of the projector 4 are made to correspond with each other. When the line passing the center of the angle of field of the camera 5 and the line passing the center of the angle of field of the projector 4 are made to correspond with each other, it becomes easy to control relationship between the projection image and the capture image, which is comfortable.

The projector 4 adopts the optical system with the tilt angle as described above. Therefore, when the projector 4 and the camera 5 are directly placed on the bottom plate 34, the line passing the center of the angle of field of the camera 5 and the line passing the center of the angle of field of the projector 4 do not correspond with each other.

Consequently, in FIG. 4, a supporting member 35 which tilts the projector 4 from the horizontal surface by a given angle (i.e., an angle in which the line passing the center of the angle of field of the camera 5 and the line passing the center of the angle of field of the projector 4 correspond with each other) is provided between the bottom of the projector 4 and the bottom plate 34 of the housing 31. The supporting member 35 is fixed onto the bottom plate 34 of the housing 31, and is further rigidly fixed to the projector 4 with screws, a bonding adhesive, a weld, and so on.

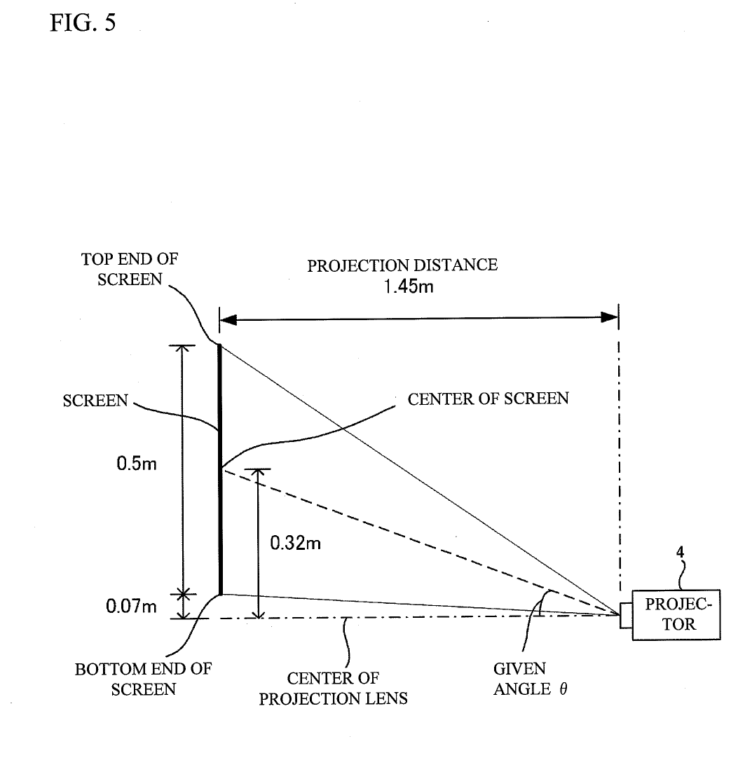

The above-mentioned given angle is calculated by the specifications of the projector 4. For example, it is assumed that the projector 4 has specifications which can make an image fit a screen and project the image onto the screen, in a state where a projection distance is 1.45 meters and the bottom of the screen 0.5 meters in height is located at a position of 0.07 meters above the center of the projection lens, as shown in FIG. 5. In this case, since the center of the screen is located at a position of 0.32 meters above the center of the projection lens, and the projection distance is 1.45 meters, the given angle θ is calculated by an expression as follows:

θ=tan⁻¹(0.32/1.45)

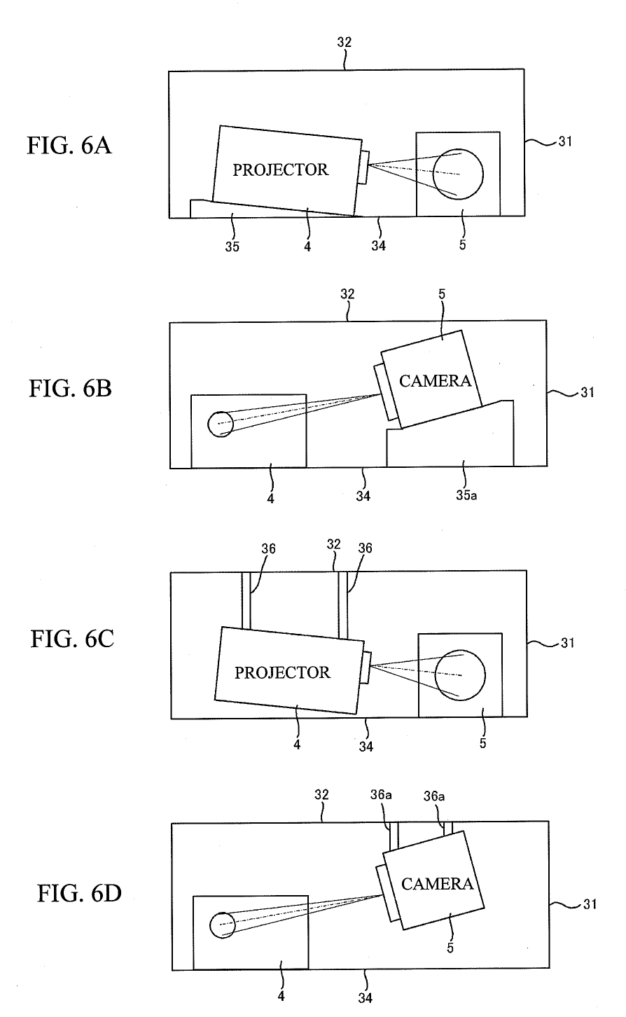

In this case, the supporting member 35 has an inclined surface tilted from the horizontal surface by the given angle (θ=tan⁻¹(0.32/1.45)), and the projector 4 is fixed onto the inclined surface. FIG. 6A shows arrangement relationship between the projector 4 and the camera 5 in the case where the projector 4 and the camera 5 are viewed from a direction A in FIG. 4.

Even when a supporting member 35a is provided between the bottom plate 34 of the housing 31 and the camera 5, as shown in FIG. 6B, the line passing the center of the angle of field of the camera 5 and the line passing the center of the angle of field of the projector 4 can be made to correspond with each other. In this case, similarly to the supporting member 35, the supporting member 35a has the inclined surface tilted from the horizontal surface by the given angle which is calculated by the specifications of the projector 4.

As shown in FIGS. 6C and 6D, the projector 4 or the camera 5 may be suspended from the top panel 32 via suspended members 36 or 36a so that the projector 4 or the camera 5 is tilted from the top panel 32 of the housing 31 by the given angle.

A method that makes the line passing the center of the angle of field of the camera 5 and the line passing the center of the angle of field of the projector 4 correspond with each other is not limited to the method using the supporting member 35 or 35a, or the suspended members 36 or 36a. Any other method that can tilt the projector 4 or the camera 5 by the given angle calculated by the specifications of the projector 4 may also be employed.

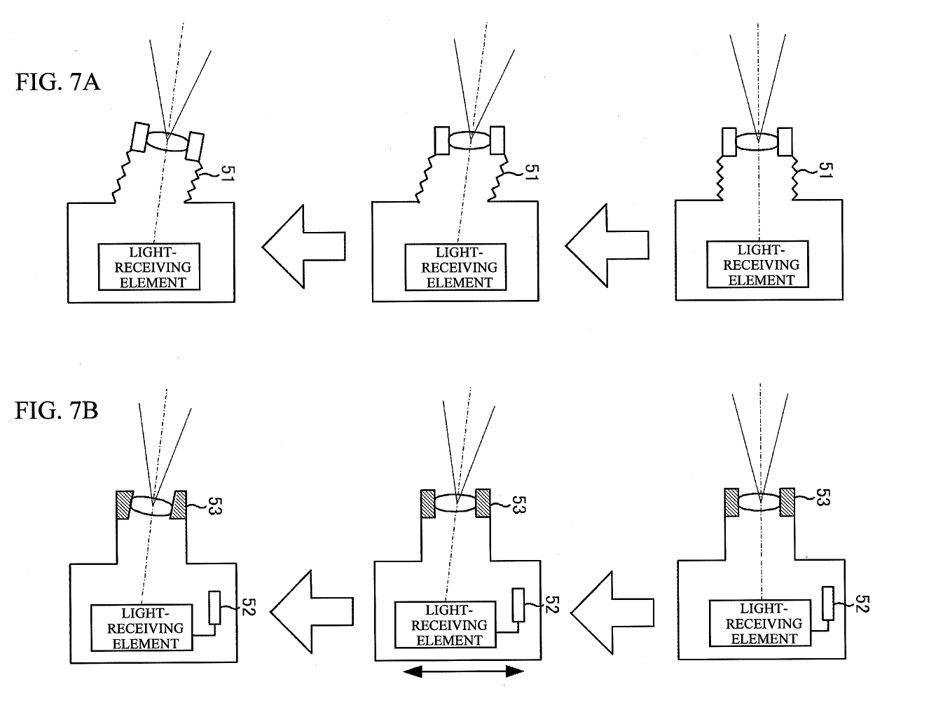

Although in the above-mentioned main unit 6, the projector 4 adopts the optical system with the tilt angle and the camera 5 adopts the optical system with no tilt angle, the camera 5 may have the tilt angle, as shown in FIG. 7a or 7B. Even when both of the projector 4 and the camera 5 have the tilt angles, the projector 4 and the camera 5 can be used in the main unit 6 if the line passing the center of the angle of field of the camera 5 and the line passing the center of the angle of field of the projector 4 correspond with each other. The camera 5 in FIG. 7A has a lens shifting unit 51 that shifts a capture lens from side to side and up and down or back and forth, and is composed of a member which can expand and contract. The camera 5 in FIG. 7B has a light-receiving element shifting unit 52 that shifts the light-receiving element from side to side and up and down, and an engaging part 53 that fixes the capture lens.

Even when the camera 5 adopts the optical system with the tilt angle and the projector 4 adopts the optical system with no tilt angle, the axis and the angle of field of the camera 5 and the axis and the angle of field of the projector 4 can be made to correspond with each other if the projector 4 or the camera 5 is tilted by the given angle which is calculated by the specifications of the camera 5. In this case, a method that makes the axis and the angle of field of the camera 5 and the axis and the angle of field of the projector 4 correspond with each other may use not only the method using the supporting member 35 or 35a, or the suspended members 36 or 36a but also other methods.

As shown in the bottom of FIG. 7B, the engaging part 53 of the camera 5 is also tilted from the horizontal surface by an amount of an angle in which the line (i.e., the optical axis) passing the center of the capture lens corresponds with a line passing the center of the angle of field. Accordingly, the capture lens fixed to the engaging part 53 is also tilted from the horizontal surface by the amount of the angle, and hence the influence of the lens aberration of the capture lens is reduced. In the case of the camera 5 shown in the bottom of FIG. 7A, the lens shifting unit 51 can expand and contract so as to tilt the capture lens. Therefore, the lens shifting unit 51 may be tilted by the amount of the angle in which the line (i.e., the optical axis) passing the center of the capture lens corresponds with a line passing the center of the angle of field, and be kept in the tilted state.

It should be noted that the present invention is not limited to those exemplary embodiments, and various modifications may be made to them without departing from the scope of the invention.

What is claimed is:

1. An optical apparatus comprising:
a projection device that projects a projection image onto a projection area; and
a capture device that is arranged so that the position of a principal point of the projection device optically corresponds with that the position of a principal point of the capture device, and captures the projection area,
wherein at least one of the projection device and the capture device has an optical system with a tilt angle, and the projection device and the capture device are arranged so that a line passing the center of an angle of field of the projection device and a line passing the center of an angle of field of the capture device correspond with each other.

2. The optical apparatus according to claim 1, wherein the angle of field of the projection device and the angle of field of the capture device correspond with each other.

3. The optical apparatus according to claim 1, wherein:
the projection device having the optical system with the tilt angle includes an engaging portion that fixes a projection lens; and
the engaging portion tilts and fixes the projection lens so that the line passing the center of an angle of field of the projection device, and an optical axis of the projection device correspond with each other.

4. The optical apparatus according to claim 1, wherein:
the capture device having the optical system with the tilt angle includes an engaging portion that fixes a capture lens; and
the engaging portion tilts and fixes the capture lens so that the line passing the center of an angle of field of the capture device, and an optical axis of the capture device correspond with each other.

5. An optical system comprising:
an optical apparatus including
a projection device that projects a projection image onto a projection area, and
a capture device that is arranged so that the position of a principal point of the projection device optically corresponds with that the position of a principal point of the capture device, and captures the projection area,
wherein at least one of the projection device and the capture device has an optical system with a tilt angle, and the projection device and the capture device are arranged so that a line passing the center of an angle of field of the projection device and a line passing the center of an angle of field of the capture device correspond with each other; and
an information processing apparatus that transmits information to be projected to the projection device, and receives an image captured with the capture device.
